(19) United States
(12) Patent Application Publication
(10) Pub. No.: US 2007/0100014 A1
(43) Pub. Date: May 3, 2007

(54) Polypropylene, polypropylene resin composition and foamed article

(75) Inventors: Kenichiro Yada, Sodegaura-shi (JP); Akinobu Sakamoto, Sodegaura-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/582,965

(22) Filed: Oct. 19, 2006

(30) Foreign Application Priority Data
Oct. 27, 2005 (JP) 2005-312423

(51) Int. Cl. B29C 44/34

(52) U.S. Cl. 521/142; 526/351

(57) ABSTRACT

A polypropylene is disclosed which is a linear polypropylene having a ratio of a Z-average molecular weight Mz to a weight-average molecular weight Mw, Mz/Mw, determined by gel permeation chromatography of 4.1 or more, a swell ratio of from 1.4 to 1.8, and an activation energy of flow of from 48 to 105 kJ/(mol·K).

### BACKGROUND OF THE INVENTION

1. Technical Field

The present invention relates to a polypropylene suitable for foaming applications. More particularly, the invention relates to a polypropylene suitable as a material of foamed articles having a high expansion ratio and a high closed cell ratio, to a foaming polypropylene resin composition containing the same, and to a foamed article obtained from the same.

2. Description of the Related Art

Polypropylene is heretofore widely used as a material of foamed articles. For example, U.S. Pat. No. 5,416,169, which is also published as Japanese Unexamined Patent Application Publication No. 6-157666, discloses a linear, crystalline polypropylene with a branching index of substantially 1 as a material which can be used suitably for blow molding, expansion molding, etc.

Japanese Unexamined Patent Application Publication No. 2000-38420 discloses, as a material suitable for high-speed molding, a propylene-based copolymer having at least a terminal vinyl group originating from propylene and a carbon-carbon double bond originating from diolefin.

Further, Japanese Unexamined Patent Application Publication No. 2003-55407 discloses, as a material suitable for forming foamed articles having excellent moldability, a high closed cell ratio and excellent appearance, a propylene-based polymer having a nonlinearity of biaxial extension viscosity at a predetermined intensity and having an activation energy of flow within a specific range.

However, in the field of foam molding, it has been demanded to provide polypropylene-based resin materials which can afford foamed articles having expansion ratios and closed cell ratios higher than those of foamed articles obtained by use of the polypropylenes disclosed in the above-cited publications.

### SUMMARY OF THE INVENTION

Under such circumstances, an object of the present invention is to provide a polypropylene from which it is possible to produce foamed articles having a high expansion ratio and a high closed cell ratio.

The present invention is directed to a polypropylene which is a linear polypropylene having a ratio of the Z-average molecular weight Mz to the weight-average molecular weight Mw, Mz/Mw, determined by gel permeation chromatography of 4.1 or more, a swell ratio of from 1.4 to 1.8, and an activation energy of flow of from 48 to 105 kJ/(mol·K).

The present invention also relates to a foaming polypropylene resin composition comprising the above-mentioned polypropylene and a foaming agent.

Moreover, the present invention further relates to a foamed article formed of the polypropylene.

It is possible to produce a foamed article having a high expansion ratio and a high closed cell ratio by subjecting a foaming polypropylene resin composition comprising the polypropylene of the present invention and a foaming agent to expansion molding.

### DETAILED DESCRIPTION OF THE INVENTION

The polypropylene of the present invention is a linear polypropylene, which refers to a propylene polymer having a molecular skeleton having no long-chain branches or having substantially no long-chain branches, namely, having less than about 0.01 long-chain branches per 1000 main-chain carbon atoms.

The term “long-chain branch” as referred to herein is a branch having a skeleton with at least 6 carbon atoms. It is impossible to identify branches with a skeleton length of 6 or more carbon atoms by use of ¹³C nuclear magnetic resonance (NMR) spectroscopy.

A method for determining the amount of long-chain branches using ¹³C-NMR spectroscopy is disclosed in Randall, Rev. Macromol. Chem. Phys., C29 (2&3), pp.285-297 (1989).

The linear polypropylene of the present invention may include a short-chain branch. The term “short-chain branch” as referred to herein is a molecular branch of a skeleton having less than 6 carbon atoms, which can be identified by ¹³C-NMR spectroscopy.

The ratio of the Z-average molecular weight (Mz) to the weight-average molecular weight (Mw) of the linear polypropylene of the present invention (Mz/Mw) is 4.1 or more.

The Z-average molecular weight Mz and the weight-average molecular weight Mw are both determined by gel permeation chromatography.

Gel permeation chromatography is a measuring method which offers information about a number-average molecular weight (Mn), a weight-average molecular weight (Mw), and a Z-average molecular weight (Mz). The number-average molecular weight (Mn) is an arithmetic average produced by dividing the sum total of molecular weights by the number of the molecules. It is an average molecular weight depending simply on the number of the molecules. The weight-average molecular weight (Mw) is a second power-average of molecular weight and it is an average molecular weight depending on the number of large molecular weights more than the number-average molecular weight (Mn) does. The Z-average molecular weight (Mz) is an average molecular weight defined as being a third power-average of molecular weight.

Gel permeation chromatography may be performed in a solvent orthodichlorobenzene at 152° C. using a Tosoh HLC-8121 GPC/HT apparatus with TSKgel GMHHR-H(20)/HT column (3 columns) at a solution concentration of 5-mg sample in 5-ml orthodichlorobenzene at a flow rate of 1 ml/min.

The value produced by dividing the weight-average molecular weight a polymer by the Q factor of the polymer is the weight-average molecular chain length Aw of the polymer. Likewise, the value produced by dividing the Z-average molecular weight a polymer by the Q factor of the polymer is the Z-average molecular chain length Az of the polymer. Therefore, the Mz/Mw ratio of a polymer is equivalent to the Az/Aw of the polymer.

The measurement by gel permeation chromatography is disclosed in more detail in, for example, Slade, P. E. Ed., Polymer Molecular Weights Part II, Marcel Dekker, Inc., N.Y., (1975) 287-368; Rodriguez, F., Principles of Polymer Systems 3rd ed., Hemisphere Pub. Corp., N.Y., (1989) 155-160; U.S. Pat. No. 4,540,753; Verstrate et al., Macromolecules, vol. 21, (1988) 3360; and references cited therein.

When the Mz/Mw ratio is less than 4.1, cell walls will deform greatly before completion of crystallization caused by temperature fall due to foaming, resulting in foam breakage or formation of uneven cells. Therefore, the performance of resulting foamed articles may be insufficient. From the viewpoint of preventing deterioration of the appearance of molded articles due to gelation, the Mz/Mw ratio is preferably from 4.1 to 20, and more preferably from 4.5 to 15.

The linear polypropylene of the present invention has a swell ratio of from 1.4 to 1.8. Here, the swell ratio is determined by use of an MFR measuring instrument and is defined as a value calculated by dividing the diameter in mm of an extruded strand of a polymer material measured under conditions provided in ISO 1133 by the inner diameter in mm of the orifice of the MFR measuring instrument. The measurement is carried out at 190° C. MFR is an abbreviation of melt flow rate. The MFR measuring instrument may be, for example, a TAKARA MELTINDEXER X416 manufactured by Technol Seven Co., Ltd.

The swell ratio is preferably from 1.45 to 1.75, and more preferably from 1.50 to 1.70. When the swell ratio is less than 1.4, the polymer may have an insufficient melt tension, whereas when it is higher than 1.8, molded articles may have unsatisfactory appearance due to occurrence of melt fracture, etc. during molding.

The linear polypropylene of the present invention has an activation energy of flow (Ea) of from 48 to 105 kJ/(mol·K).

The activation energy (Ea) is determined through measurement of the viscoelasticity of the polymer material in a molten state at least at three temperatures.

The viscoelasticity is measured under conditions (1) through (4) provided below by use of a Rheometrics Mechanical Spectrometer RMS-800 available from Rheometrics. A master curve, which indicates the degree of dependency of the dynamic viscosity (η in Pa·sec) at 240° C. on the shear rate (ω in rad/sec), is produced by shifting dynamic viscoelasticity data at individual temperatures T (K) in accordance with the principle of temperature-time superposition. In the production of the master curve, an Arrhenius type equation shown below with respect to the shift factor (aT) is used. The activation energy (Ea)is calculated from the master curve. The activation energy (Ea) serves as an index of moldability. Conventional linear polypropylenes have activation energies, determined by the aforementioned method, from about 35 kJ/(mol·K) to about 40 kJ/(mol·K).

Conditions for measuring dynamic viscoelasticity data at individual temperatures T (K)
(1) Geometry: corn-plate
(2) Strain: 5%
(3) Shear rate: 0.1 to 100 rad/sec
(4) Temperature 180, 210, 240° C.

In samples, a proper amount of antioxidant is added. The measurement is conducted under nitrogen atmosphere.

The measurement temperature is set within a temperature range where the polymer material melts or where the polymer material does not degrade. If within the aforementioned temperature range, choice of at least three temperatures will lead to convergence of the measured values within a certain range. In order to minimize the dispersion of measurement results, it is recommended to choose measurement temperatures as many as possible within the aforementioned temperature range.

Arrhenius type equation of shift factor (aT)
log(aT)=Ea/R(1/T−1/T₀)
wherein R is the gas constant and T₀ is a standard temperature (463K).

Orchestrator is used as calculation software. A value of Ea calculated when the correlation factor r₂ obtained in linear approximation is 0.99 or more in the Arrhenius type plot, log(aT)−(1/T), is used as the activation energy of flow of the polymer material.

The linear polypropylene of the present invention can be produced by using a catalyst system comprising a solid catalyst component composed essentially of magnesium, titanium and halogen, an organoaluminium compound and dimethyl diethoxysilane.

What is preferred as the solid catalyst component composed essentially of magnesium, titanium and halogen used in the present invention is a solid catalyst component containing a trivalent titanium compound produced by reducing a titanium compound (c) represented by formula Ti(OR¹)ₐX₄₋ₐ, wherein R¹ is a hydrocarbon group having from 1 to 20 carbon atoms, X is a halogen atom, and a is an integer from 1 to 4, with an organomagnesium compound (d) in the presence of an organosilicon compound having an Si—O bond (a) and an ester compound (b), thereby obtaining a solid product; adding a mixture of an ether compound (e) and titanium tetrachloride and then an organic acid halide compound (f) to the solid product to treat it; and processing the treated solid with a mixture of an ether compound and titanium tetrachloride or a mixture of an ether compound, titanium tetrachloride and an ester compound.

(a) Organosilicon Compound having an Si—O Bond

Specific examples of the organosilicon compound having an Si—O bond (a) include tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentoxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane.

(b) Ester Compound

Mono- and polycarboxylic acid esters can be used as the ester compound (b). Examples thereof include aliphatic carboxylates, alicyclic carboxylates and aromatic carboxylates. Specific examples thereof are methyl acetate, ethyl acetate, phenyl acetate, methyl propionate, ethyl propionate, ethyl butyrate, ethyl valerate, methyl acrylate, ethyl acrylate, methyl methacrylate, ethyl benzoate, butyl benzoate, methyl toluate, ethyl toluate, ethyl anisate, diethyl succinate, dibutyl succinate., diethyl malonate, dibutyl malonate, dimethyl maleate, dibutyl maleate, diethyl itaconate, dibutyl itaconate, monoethyl phthalate, dimethyl phthalate, methyl ethyl phthalate, diethyl phthalate, di-n-propyl phthalate, diisopropyl phthalate, di-n-butyl phthalate, diisobutyl phthalate, di-n-octyl phthalate and diphenyl phthalate.

(c) Titanium Compound

The titanium compound (c) is a titanium compound represented by formula Ti(OR¹)ₐX₄₋ₐ, wherein R¹ is a hydrocarbon group having from 1 to 20 carbon atoms, X is a halogen atom, and a is an integer from 1 to 4. Specific examples of R include alkyl groups such as a methyl group, an ethyl group, a propyl group, an isopropyl group, a butyl group, an isobutyl group, a tert-butyl group, an amyl group, an isoamyl group, a tert-amyl group, a hexyl group, a heptyl group, an octyl group, a decyl group and a dodecyl group; aryl groups such as a phenyl group, a cresyl group, a xylyl group and a naphthyl group; allyl groups such as a propenyl group; and aralkyl groups such as a benzyl group. Among them, alkyl groups having from 2 to 18 carbon atoms and aryl groups having 6 to 18 carbon atoms are preferred. In particular, linear alkyl groups having from 2 to 18 carbon atoms are preferred. Further, it is also possible to use a titanium compound having two or more kinds of OR groups.

The halogen atom represented by X may be a chlorine atom, a bromine atom and an iodine atom, for example. In particular, a chlorine atom will give a better result.

The number a in the formula Ti(OR¹)ₐX₄₋ₐ representing a titanium compound is an integer from 1 to 4, preferably an integer from 2 to 4, and even more preferably an integer of 4.

Specific examples of the titanium compound represented by the formula Ti(OR¹)ₐX₄₋ₐ include titanium tetrahalide compounds such as titanium tetrachloride, titanium tetrabromide and titanium tetraiodide; alkoxytitanium trihalide compounds such as methoxytitanium trichloride, ethoxytitanium trichloride, butoxytitanium trichloride, phenoxytitanium trichloride and ethoxytitanium tribromide; dialkoxytitanium dihalide compounds such as dimethoxytitanium dichloride, diethoxytitanium dichloride, dibutoxytitanium dichloride, diphenoxytitanium dichloride and diethoxytitanium dibromide; trialkoxytitanium monohalide compounds such as trimethoxytitanium chloride, triethoxytitanium chloride, tributoxytitanium chloride, triphenoxy titanium chloride and triethoxytitanium bromide; tetralkoxytitanium compounds such as tetramethoxytitanium, tetrethoxytitanium, tetrabutoxytitanium and tetraphenoxytitanium.

(d) Organic Magnesium Compound

Examples of the organic magnesium compound (d) include Grignard compounds, dialkylmagnesium compounds and diarylmagnesium compounds. Examples of Grignard compounds include methylmagnesium chloride, ethylmagnesium chloride, ethylmagnesium bromide, ethylmagnesium iodide, propylmagnesium chloride, propylmagnesium bromide, butylmagnesium chloride, butylmagnesium bromide, sec-butylmagnesium chloride, sec-butylmagnesium bromide, tert-butylmagnesium chloride, tert-butylmagnesium bromide, amylmagnesium chloride, isoamylmagnesium chloride, hexylmagnesium chloride, phenylmagnesium chloride and phenylmagnesium bromide.

Examples of the dialkylmagnesium compounds and diarylmagnesium compounds include dimethylmagnesium, diethylmagnesium, dipropylmagnesium, diisopropylmagnesium, dibutylmagnesium, di-sec-butylmagnesium, di-tert-butylmagnesium, butyl-sec-butylmagnesium, diamylmagnesium, dihexylmagnesium, diphenylmagnesium and butylethylmagnesium.

(e) Ether Compound

Examples of the ether compound include dialkyl ethers such as diethyl ether, dipropyl ether, diisopropyl ether, dibutyl ether, diisobutyl ether, diamyl ether, diisoamyl ether, dineopentyl ether, dihexyl ether, dioctyl ether, methyl butyl ether, methyl isoamyl ether and ethyl isobutyl ether. Among these, dibutyl ether and diisoamyl ether are used particularly preferably.

(f) Organic Acid Halide Compound

Mono- and polycarboxylic acid halides may be used as the organic acid halide compound. Examples thereof include aliphatic carboxylic acid halides, alicyclic carboxylic acid halides and aromatic carboxylic acid halides. Specific examples include acetyl chloride, propionyl chloride, butyroyl chloride, valeroyl chloride, acryloyl chloride, methacryloyl chloride, benzoyl chloride, toluyl chloride, anisoyl chloride, succinoyl chloride, malonyl chloride, maleyl chloride, itaconoyl chloride and phthaloyl chloride.

Among these organic acid halide compounds, aromatic carboxylic acid halides such as benzoyl chloride, toluoyl chloride and phthaloyl chloride are preferred. Phthaloyl chloride is particularly preferred.

The organoaluminum compound to be used in the present invention is one having at least one aluminum-carbon bond in the molecule. Typical examples thereof are represented by the following formulas:
R²_{w}AlY_{3-w}
R³R⁴Al—O—AlR⁵R⁶
wherein R² through R⁶ each independently denote a hydrocarbon group having from 1 to 20 carbon atoms; Y represents a halogen atom, a hydrogen atom or an alkoxy group; and w is 2 or 3.

Examples of such organoaluminum compounds include trialkylaluminums such as triethylaluminum, triisobutylaluminum, trihexylaluminum and trioctylaluminum; dialkylaluminum hydrides such as diethylaluminum hydride and diisobutylaluminum hydride; dialkylaluminum halides such as diethylaluminum chloride; mixtures of trialkylaluminums and dialkylaluminum halides such as a mixture of triethylaluminum and diethylaluminum chloride; and alkylalumoxanes such as tetraethyldialumoxane and tetrabutyldialumoxane.

Among such organoaluminum compounds, trialkylaluminums, mixtures of trialkylaluminums and dialkylaluminum halides and alkylalumoxanes are preferred. In particular, triethylaluminum, triisobutylaluminum, a mixture of triethylaluminum and diethylaluminum chloride, and tetraethyldialumoxane are preferred.

The silicon compound to be used in the present invention is dimethyldiethoxysilane. Use of a silicon compound other than dimethyldiethoxysilane will result in deterioration of the foaming characteristics, processing characteristics and physical properties of products due to generation of high-molecular-weight substances having unnecessarily high molecular weights and increase in the proportion of low-crystallinity components.

The temperature of propylene polymerization is typically from −30 to 300° C., and preferably from 20 to 180° C. From the industrial and economical point of view, the polymerization pressure is normally from normal pressure to 100 kg/cm², and preferably from 2 to 50 kg/cm².

The polymerization may be conducted either in a batch system or in a continuous system. Examples of polymerization methods include slurry polymerization or solution polymerization using an inert hydrocarbon solvent such as propane, butane, isobutane, pentane, hexane, heptane and octane, bulk polymerization using propylene, which is in the liquid state at the polymerization temperature, as a medium, and vapor phase polymerization.

In the present invention, it is possible to polymerize propylene in the presence of the aforementioned catalyst. In addition, prepolymerization may be conducted before the polymerization (main polymerization) of propylene in the presence of the catalyst. It is also permitted to conduct prepolymerization and then carry out main polymerization of propylene in the presence of a catalyst for propylene polymerization comprising the aforementioned solid catalyst component, organoaluminum compound and dimethyldiethoxysilane.

Moreover, it is also permitted to conduct main polymerization of propylene in the presence of a catalyst for propylene polymerization comprising the aforementioned solid catalyst component, organoaluminum compound and dimethyldiethoxysilane without performing prepolymerization.

The amount of the organoaluminum compound for use in the main polymerization is normally within the range of from 1 to 1000 mol, and preferably within the range of from 5 to 600 mol per mole of titanium atoms in the solid catalyst component.

Examples of the polypropylene of the present invention include:

(1) propylene homopolymers;

(2) random copolymers of propylene and comonomers such as linear monoolefin, branched-chain monoolefin and vinylcyclohexane, in an amount such that the crystallinity is not lost; and

(3) block copolymers produced by homopolymerization of propylene or copolymerization of propylene with ethylene or α-olefin having from 4 to 12 carbon atoms (former stage polymerization) followed by polymerization in one stage or two or more stages of a-olefin having from 3 to 12 carbon atoms and ethylene (latter stage polymerization).

In the random copolymer (2), the “amount of the comonomer such that the crystallinity is not lost” varies depending on the kind of comonomer, but in the case of ethylene for example, the amount of repeating units derived from ethylene in the copolymer is normally up to 10% by weight. In the case of α-olefin such as 1-butene, the amount of repeating units derived from α-olefin in the copolymer is normally up to 30% by weight, and preferably up to 10% by weight.

In the former stage polymerization in the case of the block copolymer (3) for example, the amount of ethylene polymerized is normally up to 10% by weight, preferably up to 3% by weight, and even more preferably up to 0.5% by weight and the amount of α-olefin polymerized is normally up to 15% by weight, preferably up to 10% by weight. In the latter stage polymerization, the amount of ethylene polymerized is normally from 20 to 80% by weight, and preferably from 30 to 50% by weight.

In the preparation of the linear polypropylene of the present invention, hydrogen may optionally be used for adjusting the molecular weight. A polymerization method using no hydrogen may also be used. The polymerization method most desirable from the viewpoint of melt tension maintenance is a polymerization method which fails to use hydrogen.

In the preparation of the linear polypropylene of the present invention, an organoaluminum compound and dimethyldiethoxysilane are added so that the ratio of the number of Si atoms in the dimethyldiethoxysilane to the number of Al atoms in the organoaluminum compound, Si/As (mol/mol), falls within the range of from 0.01 to 1.0. In order to prevent polymer powder from sticking together, the ratio of the number of Si atoms in the dimethyldiethoxysilane to the number of Al atoms in the organoaluminum compound, Si/As (mol/mol), is preferably from 0.03 to 0.5 and more preferably from 0.05 to 0.3.

The polypropylene resin composition of the present invention is a polypropylene resin composition comprising the linear polypropylene of the present invention and a foaming agent.

The foaming agent used in the present invention may be either a physical foaming agent or a chemical foaming agent. Examples of the physical foaming agent include carbon dioxide gas, nitrogen gas, air, propane, butane, pentane, hexane, dichloroethane, dichlorodifluoromethane, dichloromonofluoromethane, trichloromonofluoromethane and their combinations. Nitrogen gas, carbon dioxide gas, air, etc., which are safe and environment-friendly, are preferable. Carbon dioxide gas is more preferable. Carbon dioxide gas is preferred because its solubility in polypropylene resin is relatively high among inorganic gases. When carbon dioxide gas is under a pressure of 7.4 MPa or more, at a temperature of 31° C. or more, it is in a supercritical state where it can be diffused or dissolved well in resin.

Examples of the chemical foaming agent include sodium bicarbonate, mixtures of sodium bicarbonate and an organic acid such as citric acid, sodium citrate and stearic acid, isocyanate compounds such as tolylene diisocyanate and 4,4′-diphenylmethane diisocyanate, azo or diazo compounds such as azodicarbonamide, azobisbutyronitrile, barium azodicarboxylate, diazoaminobenzene and trihydrazinotriazine, hydrazine derivatives such as benzenesulphonyl hydrazide, p,p′-oxybis(benzenesulphonyl hydrazide) and toluenesulfonyl hydrazide, nitroso compounds such as N,N′-dinitrosopentamethylenetetramine and N,N′-dimethyl-N,N′-dinitroso terephthalamide, semicarbazide compounds such as p-toluenesulfonyl semicarbazide and 4,4′-oxybis(benzenesulfonyl semicarbazide), azide compounds, triazole compounds, and their compositions. Sodium bicarbonate, citric acid and azodicarbonamide are preferred.

Although just one type of foaming agent, namely a physical foaming agent or a chemical foaming agent, may be used, use of a combination of a physical foaming agent and a chemical foaming agent is also permitted.

When using a chemical foaming agent, a foaming aid may be used together in order to adjust the decomposition temperature and decomposition rate. For example, since azodicarbonamide singly exhibits a decomposition temperature as high as about 200° C., a small amount of zinc oxide, zinc stearate, urea, etc. may be added as a foaming aid when low-temperature processing is intended.

In use of a physical foaming agent, a cell nucleating agent is usually added. Examples of such a cell nucleating agent include talc, silica, diatomite, calcium carbonate, magnesium carbonate, barium sulfate, aluminum hydroxide, magnesium hydroxide, calcium hydroxide, calcium silicate, zeolite, mica, clay, wollastonite, hydrotalcite, magnesium oxide, zinc oxide, zinc stearate, calcium stearate, beads of polymer such as PMMA, and synthetic aluminosilicate. Moreover, a small amount of chemical foaming agent such as those previously mentioned may be added.

The amount of the foaming agent added is determined properly depending on the desired expansion ratio. In the use of carbon dioxide gas as a physical foaming agent, the amount of the gas added is normally from 0.1 to 4 PHR. For example, in the production of a foamed sheet with an expansion ratio of 3, the amount of the gas added is 0.3 PHR, and for an expansion ratio of 5, about 0.6 PHR.

A polypropylene resin composition can be produced by a method comprising heating the linear polypropylene of the present invention to a proper temperature with a kneading device or stirrer, and kneading it while adding a proper shear stress. Examples of such a kneading device include rolls, co-kneaders, Banbury mixers, Brabenders, single screw extruders and twin screw extruders. Examples of such a stirrer include horizontal or vertical stirrers, e.g. double helical ribbon stirrers, etc.

According to demand, stabilizers, such as antioxidants, metal deactivators, phosphorus-based processing stabilizers, UV absorbers, UV stabilizers, fluorescent brighteners, metallic soaps and acid adsorbent, and additives, such as crosslinking agents, chain transfer agents, nucleating agents, lubricants, plasticizers, fillers, reinforcing agents, pigments, dyes, flame retardants and antistatic agents, may be added.

Moreover, in order to add such additives or other resins, melt-kneading may be repeated after the polypropylene of the present invention is obtained. A polypropylene resin composition may be produced by preparing a masterbatch by melt-kneading one part of linear polypropylene with additives or other resins and then mixing the mixture and the remaining part of linear polypropylene.

Foamed articles can be produced by foaming the polypropylene resin composition of the present invention. To the production of foamed articles, extrusion using an extruder may be applied.

As the extruder, single screw or multi screw extruders which are normally used for extrusion forming may be used. Tandem extruders composed of a combination of two or more extruders may also be used. In particular, co-rotating twin screw extruders are preferred. Extruders are preferable which have a structure such that a large amount of material can be extruded per screw rotation so that a predetermined amount of extrudate can be formed through screw rotations as less as possible and such that shear due to screw rotation generates a heat reduced as much as possible. It is more preferable that an extruder be configured to be temperature-controllable by circulation of a coolant in a screw. As a die, which is attached to an extruder, dies such as those used for common extrusion forming, e.g. T-dies and circular dies, may be used.

The form of the foamed article of the present invention may be in a strand form or a sheet form, for example. It is typically in a sheet form. In the case of being in a sheet form, the expansion ratio of the foamed article is from 1.3 to 10 times and the thickness is from 0.5 to 10 mm. The foamed article of the present invention in a sheet form may be a multilayer foamed sheet having at least one foamed layer made of the polypropylene of the present invention. The material and the number of layers other than the foamed layer made of the polypropylene of the present invention are not particularly restricted. Such a multilayer foamed sheet can be produced by conventional multilayer co-extrusion foam forming.

Applications of the foamed article of the present invention include packages, boxes, partition boards, food containers, stationery, building materials and automotive interior or exterior components. A thin material, such as sheet and film, may be adhered to one or both surfaces of a foamed sheet. Alternatively, a coating layer may be formed through application of an antistatic agent solution or a gas barrier resin composition solution, for example. In such cases, it is preferable to subject a surface of the foamed sheet to surface treatments, such as corona treatment and ozone treatment.

The thin material to be adhered may be selected from conventional ones depending on the application. Examples thereof include thin plates made of metal such as aluminum and iron, thermoplastic resin, paper, synthetic paper, hemp and glass wool, and nonwoven or woven fabric of various materials.

In the case of using a foamed article of the present invention in the form of foamed sheet as a food packing material, it is preferable to laminate a propylene resin film or gas barrier resin film with a thickness of from 10 to 100 μm to at least one surface of the foamed sheet. The gas barrier resin may be a conventional gas barrier resin, such as ethylene-vinyl alcohol copolymer, polyvinylidene chloride, polyvinyl alcohol and polyamide.

In the case of using a foamed sheet of the present invention as an automotive interior material, it is preferable to use it after laminating nonwoven fabric, woven fabric, hemp, glass wool or the like to at least one surface of the foamed sheet.

In the case of using a foamed sheet as a partition of a box, it is preferable to laminate, to at least one surface of the foamed sheet, another foamed sheet with a higher expansion ratio for the purpose of content protection.

A thin material can be adhered to a foamed sheet of the present invention by, for example, (1) a method in which an adhesive is applied to a surface of the foamed sheet and/or a surface of the thin material and then the foamed sheet and thin material are laminated together, (2) a method in which the thin material with an adhesive resin film laminated thereon is heated so that the adhesive resin film is molten and then the thin material is laminated with the foamed sheet, (3) a method in which a surface of the foamed sheet and/or a surface of the thin material is molten with a heater or hot air and then the foamed sheet and the thin material are laminated together, and (4) a method in which a molten resin is extruded between the thin material and the foamed sheet and then they are laminated together.

The foamed sheet of the present invention which may have a thin material adhered thereon can also be used in the form of a shaped article produced by shaping the foamed sheet into a desired shape by thermoforming such as vacuum forming. For thermoforming, conventional methods may be used, for example, vacuum forming and heat creasing (i.e. making creases by heat pressing).

### EXAMPLES

The present invention is described below with reference to examples and comparative examples.

(1) Preparation of Polypropylene

Polypropylenes were produced by the methods disclosed in Polymerization Examples 1 through 4. Physical properties of the polypropylenes obtained are shown in Table 1.

(2) Confirmation of Linear Polypropylene

A polypropylene was subjected to ¹³C-NMR measurement under the following conditions.

In about 3 ml of a mixed solvent of 1,2-dichlorobenzene/1,2-orthodichlorobenzene-d4 (volume ratio: 80/20), about 200 mg of a sample was dissolved at 135degC. A Bruker AVANCE 600 NMR equipped with a probe for a 10-mm-diameter glass test tube was used. The mixed solvent of 1,2-dichlorobenzene/1,2-orthodichlorobenzene-d4 (volume ratio: 80/20) contained 500 ppm of 2.6-tert-butyl-4-methylphenol.

Absorptions were assigned by making reference to A. Zambelli et al., Macromolecules, Vol. 8, 687 (1975) for propylene homopolymers and M. Kakugo et al., Macromolecules, Vol. 15, 1150 (1982).

In the chemical shift range of from 10 to 50 ppm, differences between characteristic absorptions detected in the ¹³C-NMR measurements of the polypropylenes produced in Polymerization Examples 1 through 4 and those disclosed in the references were checked. When all the characteristic absorptions detected agree well with those disclosed in the references, it is concluded that no polymers other than linear polypropylene were produced.

(3) Preparation of Polypropylene Resin Composition for Foaming

Polypropylene resin compositions for foaming were prepared by the methods disclosed in Production Examples 1 through 4.

(4) Production of Foamed Article

Extrusion foamed articles were produced and extrusion foaming tests were conducted by the methods disclosed in Example 1 and Comparatives Example 1 through 3.

(5) Expansion Ratio and closed Cell Ratio

The density of a foamed article, ρ(water), was determined using the immersion method according to JIS K7112. On the other hand, the density of the foamed article, ρ(air), was determined byusinganairpycnometerinaccordancewithASTM-D2856. Then, an expansion ratio and a closed cell ratio were calculated by the following equations. It is noted that the density of a polypropylene resin composition for foaming, ρ(PP), was 0.90g/cm³.
Expansion ratio=ρ(PP)/ρ(water)
Closed cell ratio=(ρ(PP)/ρ(air)−1)/(ρ(PP)/ρ(water)−1)×100

### Polymerization Example 1

### Preparation of Polypropylene

(1) Preparation of Reduced Solid Product

The atmosphere in a 500-ml flask equipped with a stirrer and a dropping funnel was replaced by nitrogen. Thereafter, 290 ml of hexane, 8.9 ml (8.9 g, 26.1 mmol) of tetrabutoxytitanium, 3.1 ml (3.3 g, 11.8 mmol) of diisobutyl phthalate and 87.4 ml (81.6 g, 392 mmol) of tetraethoxysilane were charged therein to form a homogeneous solution. Then, 199 ml of a solution of n-butylmagnesium chloride in di-n-butyl ether (made by Yuki Gosei Kogyo Co., Ltd., n-butylmagnesium chloride concentration: 2.1 mmol/l) was dropped over 5 hours from the dropping funnel while the temperature inside the flask was kept at 6° C. After the completion of the dropping, stirring was continued for additional 1 hour at 6° C., and for further additional 1 hour at room temperature. Then, the mixture was subjected to solid-liquid separation and the resulting solid was washed repeatedly with three 260-ml portions of toluene. Addition of a proper amount of toluene adjusted the slurry concentration to 0.176 g/ml. Part of the solid product slurry wassampledandsubjectedtocompositionanalysis. Asaresult, it was found that the solid product contained 1.96% by weight of titanium atom, 0.12% by weight of phthalate, 37.2% by weight of ethoxy group and 2.8% by weight of butoxy group.

(2) Preparation of Solid Catalyst Component

The atmosphere in a 100-ml flask equipped with a stirrer, a dropping funnel and a thermometer was replaced by nitrogen. Thereafter, 52-ml portion of the slurry containing the solid product obtained in (1) above was charged therein. Then, 25.5 ml of supernatant was removed, followed by addition of a mixture of 0.80 ml (6.45 mol) of dibutyl ether and 16.0 ml (0.146 mol) of titanium tetrachloride, and subsequent addition of 1.6 ml (11.1 mnol: 0.20 ml for 1-gram solid product) of phthaloyl dichloride. The resulting mixture was heated to 115° C. and was stirred at this temperature for 3 hours. After the completion of the reaction, the mixture was subjected to solid-liquid separation and the resulting solid was washed repeatedly with two 40-ml portions of toluene at that temperature. Subsequently, a mixture of 10.0 ml of toluene, 0.45 ml (1.68 mmol) of diisobutyl phthalate, 0.80 ml (6.45 mmol) of butyl ether and 8.0 ml (0.073 mol) of titanium tetrachloride was added, followed by treatment at 115° C. for 1 hour. After the completion of the reaction, the mixture was subjected to solid-liquid separation at 115° C. and the resulting solid was washed repeatedly with three 40-ml portions of toluene and three 40-ml portions of hexane at that temperature. The resulting solid was dried under reduced pressure to yield 7.36 g of solid catalyst component. The solid catalyst component contained 2.18% by weight of titanium atom, 11.37% by weight of phthalate, 0.3% by weight of ethoxy group and 0.1% by weight of butoxy group. Observation by a stereoscopic microscope revealed that the solid catalyst component had good particle properties without containing fine powder.

(3) Polymerization of Propylene

Into a stainless steel autoclave with an internal volume of 3 liters which had been dried under reduced pressure and then replaced by argon, 780 g of propylene was charged. Subsequently, 4.4 mmol of triethylaluminum, 0.44 mmol of dimethyldiethoxysilane and 126.5-mg portion of the solid catalyst component prepared in (2) above were mixed at a time and the mixture was charged into the autoclave, followed by polymerization at 85° C. One hour later, unreacted monomer was purged and the polymerization was thereby ended. Drying the resulting polymer at 60° C. for 5 hours under reduced pressure provided 372 g of polypropylene powder. Therefore, the yield of the polypropylene per gram of the solid catalyst component (hereinafter, PP/Cat) was PP/Cat=2,940 (g/g).

(4) Confirmation of Linear Polypropylene

The polypropylene obtained was subjected to ¹³C-NMR measurement by the method mentioned above. The characteristic absorptions of the sample agreed well with those disclosed in the reference of A. Zambelli et al. This fact shows that no polymer other than linear polypropylene were produced.

### Production Example 1

### Preparation of Polypropylene Resin Composition)

To 100 parts by weight of the polypropylene powder obtained in Polymerization Example 1, 0.05 parts by weight of calcium stearate, 0.2 parts by weight of Irganox 1010 (manufactured by Ciba Specialty Chemicals) and 0.1 parts by weight of Sumilizer GP (manufactured by Sumitomo Chemical Co., Ltd.) were added,followed by melt-kneading with a 20-mmφ single screw extruder (L/D=12.6) manufactured by Tanabe Plastics Machinery Co., Ltd. at a temperature of 200° C. and a screw speed of 40 rpm. The kneadate was pelletized at an extrusion rate of 1.1 kg/h to yield a polypropylene resin composition.

### Example 1

(Foaming Agent)

CELLMIC M194 manufactured by Sankyo Kasei Co., Ltd. was used as a foaming agent. M194 was a masterbatch containing polyethylene (SUMIKATHENE G804 manufactured by Sumitomo Chemical Co., Ltd.) as a base resin and also containing 30% by weight of a foaming agent and a foaming aid. The foaming agent and the foaming aid were composed of 88.8% by weight of sodium bicarbonate, 4.8% by weight of azodicarbonamide, 4.8% by weight of zinc oxide and 1.6% by weight of zinc stearate. (Productions of polypropylene resin composition for foaming and extrusion foamed article)

To the polypropylene resin composition produced in Production Example 1, 6 PHR of M194 was added and pellet-blended withatumbler. Theresultingmixture waschargedinto a 20-mmφ single screw extruder through a hopper. The extruder had a die attached thereto which had one hole 3.0 mm in diameter. The extruder and the die were set to have a temperature of 160° C., 170° C., 180° C. and 200° C. Extrusion was carried out at each set temperature at an extrusion rate of 800 g/h. Thus, extrusion foamed articles were produced. Resin temperature was measured at the die exit.

For the foamed articles in a strand form, the expansion ratio and the closed cell ratio were measured and the results were shown in Table 2.

### Polymerization Example 2

### Preparation of Polypropylene

Into a stainless steel autoclave with an internal volume of 3 liters which had been dried under reduced pressure and then replaced by argon, 1-liter of heptane was charged. Subsequently, 4.4 mmol of triethylaluminum, 0.44 μmol of tert-butyl-n-propyldimethoxysilane and 132.1-mg portion of the solid catalyst component prepared in Polymerization Example 1 were added and then propylene was fed while the temperature inside the autoclave was raised to 70° C. After the temperature inside the autoclave arrived at 70° C. and the propylene pressure at 0.6 MPa, polymerization was performed for 1 hour while the propylene pressure was kept constant. After a lapse of 1 hour, 10 ml of 2-methyl-propyl alcohol was added and was stirred for 30 minutes. Then, unreacted monomer was purged and the polymerization was thereby ended. Drying the resulting polymer at 60° C. for 5 hours under reduced pressure provided 359 g of polypropylene powder. Therefore, the yield of the polypropylene per gram of the solid catalyst component was PP/Cat=2,710 (g/g).

Confirmation of Linear Polypropylene

The polypropylene obtained was subjected to ¹³C-NMR measurement by the method mentioned above. The characteristic absorptions of the sample agreed well with those disclosed in the reference of A. Zambelli et al. This fact shows that no polymer other than linear polypropylene were produced.

### Production Example 2

### Preparation of Polypropylene Resin Composition

A polypropylene resin composition was produced by conducting operations the same as those of Production Example 1, except using the polypropylene powder prepared in Polymerization Example 2.

### Comparative Example 1

### Productions of Polypropylene Resin Composition for Foaming and Extrusion Foamed Article

An extrusion foamed article was produced by conducting operations the same as those of Example 1, except using the polypropylene resin composition prepared in Production Example 2.

For the foamed articles in a strand form, the expansion ratio and the closed cell ratio were measured and the results were shown in Table 2.

### Polymerization Example 3

### Preparation of Block Copolymer

Into a polymerization reactor with an internal volume of 5.57 m³ equipped with a stirrer, 2.5 m³ of heptane was charged and then 8.6 mol of triethylaluminum and 1.3 mol of tert-butyl-n-propyldimethoxysilane were charged. Thereafter, the temperature in the polymerization reactor started to be raised. At the time of arrival at 75° C., a 155.1-gram portion of the solid catalyst component prepared in Polymerization Example 1 was fed while the hydrogen concentration in the polymerization reactor was kept at 14 vol %. Then, polymerization was conducted at 75° C. for 2 hours while the pressure was increased up to 0.8 MPa with propylene. Subsequently, following degassing, an ethylene/propylene mixed gas was fed so that the vapor phase composition was maintained at ethylene/propylene=46/54 (in volume) and polymerization was continued at 50° C. until arrival of the proportion of an ethylene-propylene random copolymer at 25% by weight of the eventually resulting block copolymer while the inner pressure was kept at 0.3 MPa.

Confirmation of Linear Polypropylene

The block copolumer obtained was subjected to ¹³C-NMR measurement by the method mentioned above. The characteristic absorptions of the sample agreed well with those disclosed in the reference of M. Kakugo et al. This fact shows that no polymer other than linear polypropylene were produced.

### Polymerization Example 3

### Preparation of Polypropylene Resin Composition

A polypropylene resin composition was produced by conducting operations the same as those of Production Example 1, except using the block copolymer powder prepared in Polymerization Example 3.

### Comparative Example 2

### Productions of Polypropylene Resin Composition for foaming and Extrusion Foamed Article

An extrusion foamed article was produced by conducting operations the same as those of Example 1, except using the polypropylene resin composition prepared in Production Example 3 and the amount of M194 added was changed to 8 PHR.

For the foamed articles in a strand form, the expansion ratio and the closed cell ratio were measured and the results were shown in Table 2.

### Polymerization Example 4

### Preparation of Block Copolymer

(1) Preparation of Solid Catalyst Component Precursor

A 0.5-meter-diameter, 200-liter cylindrical reactor equipped with a stirrer having three pairs of blades each 0.35 m in diameter and also with four baffles 0. 05 m width was filled with nitrogen. Subsequently, 54 liters of hexane, 780 g of diisobutyl phthalate, 20.6 kg of tetraethoxysilane and 2.23 kg of tetrabutoxytitanium were fed and stirred. Then, to the stirred mixture, 51 liters of a solution of butylmagnesium chloride in dibutyl ether (concentration: 2.1 mol/l) was dropped over 4 hours while the temperature in the reactor was kept at 5° C. The stirring speed was 120 rpm. After the completion of the dropping, the mixture was stirred at 20° C. for 1 hour, and then a solid was collected by filtration. The solid collected was washed with three 70-liter portions of toluene at room temperature. Subsequently, 40 liters of toluene was added to form a solid catalyst component precursor slurry.

The solid catalyst component precursor contained 1.9% by weight of Ti, 35.9% by weight of ethoxy group and 3.6% by weight of butoxy group. The average particle diameter was 36 μm and the content of fine powder components as large as up to 16 μm in diameter was 0.4% by weight.

(2) Preparation of Solid Catalyst Component

A 200-liter cylindrical reactor with a shape the same that of the reactor used in (1) above was filled with nitrogen and then the solid catalyst component precursor slurry prepared in (1) above was transferred. After leaving at rest, toluene was extracted so that the slurry volume became 49.7 liters. Then, a mixed solution of 30 liters of tetrachlorotitanium and 1.16 kg of dibutyl ether and subsequently 4.23 kg of orthophthaloyl chloride were charged under stirring. The temperature in the reactor was adjusted to 110° C. and stirring was conducted for 3 hours, followed by filtration. The solid collected was washed repeatedly with three 90-liter portions of toluene at 95° C.

To the resulting solid, 70 liters of toluene was added to form a slurry. After leaving at rest, toluene was extracted so that the slurry volume became 49.7 liters. Then, a mixed solution of 15 liters of tetrachlorotitanium, 1.16 kg of dibutyl ether and 0.87 kg of diisobutyl phthalate was charged under stirring. The temperature in the reactor was adjusted to 105° C. and stirring was conducted for 1 hour, followed by filtration. The solid collected was washed repeatedly with two 90-liter portions of toluene at 95° C.

To the resulting solid, 70 liters of toluene was added to form a slurry. After leaving at rest, toluene was extracted so that the slurry volume became 49.7 liters. Then, a mixed solution of 15 liters of tetrachlorotitanium and 1.16 kg of dibutyl ether was charged under stirring. The temperature in the reactor was adjusted to 105° C. and stirring was conducted for 1 hour, followed by filtration. The solid collected was washed repeatedly with two 90-liter portions of toluene at 95° C.

To the resulting solid, 70 liters of toluene was added to form a slurry. After leaving at rest, toluene was extracted so that the slurry volume became 49.7 liters. Then, a mixed solution of 15 liters of tetrachlorotitanium and 1.16 kg of dibutyl ether was charged under stirring. The temperature in the reactor was adjusted to 105° C. and stirring was conducted for 1 hours, followed by filtration. The solid collected was washed repeatedly with three 90-liter portions of toluene and two 90-liter portions of hexane at 95° C. The resulting solid component was dried, yielding a solid catalyst component.

The solid catalyst component contained 2.2% by weight of Ti and 9.4% by weight of phthalate component.

(3) Preparation of Block Copolymer

A block copolymer was prepared in the same manner as Polymerization Example 3, except for changing the solid catalyst component used to that prepared in Polymerization Example 4, maintaining the vapor phase composition at ethylene/propylene=31/69 (in volume), and continuing the polymerization until arrival of the proportion of an ethylene-propylene random copolymer at 30% by weight of the eventually resulting block copolymer.

Confirmation of Linear Polypropylene

The block copolumer obtained was subjected to ¹³C-NMR measurement by the method mentioned above. The characteristic absorptions of the sample agreed well with those disclosed in the reference of M. Kakugo et al. This fact shows that no polymer other than linear polypropylene were produced.

### Production Example 4

### Preparation of Polypropylene Resin Composition

A polypropylene resin composition was produced by conducting operations the same as those of Production Example 1, except using the block copolymer powder prepared in Polymerization Example 4.

### Comparative Example 3

### Productions of Polypropylene Resin Composition for Foaming and Extrusion Foamed Article

An extrusion foamed article was produced by conducting operations the same as those of Example 1, except using the polypropylene resin composition prepared in Production Example 4 and the amount of M194 added was changed to 8 PHR.

For the foamed articles in a strand form, the expansion ratio and the closed cell ratio were measured and the results were shown in Table 2.

TABLE 1

| | | | Ea |
|---|---|---|---|
| | Mz/Mw | Swell ratio | (kJ/(mol · K)) |
| Example 1 | 14.5 | 1.50 | 48.7 |
| Comparative | 12.0 | 1.54 | 40.7 |
| Example 1 | | | |
| Comparative | 9.2 | 1.20 | 29.2 |
| Example 1 | | | |
| Comparative | 9.2 | 1.30 | 29.2 |
| Example 1 | | | |

TABLE 2

| | | | | Foamed article evaluation | |
|---|---|---|---|---|---|
| | Amount of | Set | Resin | Expansion | Closed cell |
| | CELLMIC M194 | temperature | temperature | ratio | ratio |
| | (PHR) | ° C. | ° C. | — | % |
| Example 1 | 6 | 160 | 161.5 | 2.63 | 100 |
| | | 170 | 169.0 | 3.90 | 100 |
| | | 180 | 179.7 | 4.30 | 100 |
| | | 200 | 200.0 | 3.25 | 40 |
| Comparative | 6 | 160 | 161.3 | 2.71 | 103 |
| Example 1 | | 170 | 170.3 | 3.82 | 103 |
| | | 180 | 179.7 | 3.72 | 103 |
| | | 200 | 201.0 | Foam | Foam |
| | | | | breakage | breakage |
| Comparative | 8 | 160 | 159.7 | 2.84 | 100 |
| Example 2 | | 170 | 168.8 | 4.29 | 99 |
| | | 180 | 179.4 | 2.41 | 42 |
| | | 200 | 199.2 | Foam | Foam |
| | | | | breakage | breakage |
| Comparative | 8 | 160 | 161.7 | 2.82 | 92 |
| Example 3 | | 170 | 169.2 | 3.66 | 74 |
| | | 180 | 179.0 | Foam | Foam |
| | | | | breakage | breakage |
| | | 200 | 198.2 | Foam | Foam |
| | | | | breakage | breakage |

Table 2 shows that in Example 1 the expansion ratio and the closed cell ratio are high.

It is also shown that in Comparative Example 1, where the activation energy of flow (Ea) was less than 45 kJ/(mol·K), neither the closed cell ratio were high.

What is claimed is:

1. A polypropylene which is a linear polypropylene having a ratio of a Z-average molecular weight Mz to a weight-average molecular weight Mw, Mz/Mw, determined by gel permeation chromatography of 4.1 or more, a swell ratio of from 1.4 to 1.8, and an activation energy of flow of from 48 to 105 kJ/(mol·K).

2. A polypropylene resin composition comprising the polypropylene according to claim 1 and a foaming agent.

3. A foamed article comprising the polypropylene according to claim 1.
